(19) United States
(12) Patent Application Publication
(10) Pub. No.: US 2009/0234858 A1
(43) Pub. Date: Sep. 17, 2009

(54) Use Of A Single Service Application Instance For Multiple Data Center Subscribers

(75) Inventors: William David Taylor, Redmond, WA (US); Zachary D. Rosenfield, Seattle, WA (US); Titus C. Miron, Seattle, WA (US); Jason M. Cahill, Woodinville, WA (US); Umesh Unnikrishnan, Sammamish, WA (US); Harshal Ingole, San Jose, CA (US); Mark J. Walker, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/049,284

(22) Filed: Mar. 15, 2008

(51) Int. Cl. G06F 17/30

(52) U.S. Cl. 707/10; 707/E17.01

(57) ABSTRACT

This disclosure describes techniques of using a single instance of a network service application to provide a network service on behalf of multiple subscribers of a data center. As described herein, a data center may execute an instance of a service application that provides a service that is used by web applications that serve web sites associated with different subscribers of the data center. The instance of the service application stores service-specific data associated with the different web sites in separate partitions of a database. Storing the service-specific data associated with different web sites in separate partitions of the database enables the instance of the service application to control the data used to perform the service on a subscriber-by-subscriber basis while allowing for shared data between subscribers.

### BACKGROUND

Web pages are important means for communication and collaboration for enterprises. An enterprise may use web pages to communicate with its employees, with the public, with its partners, and with other groups. An enterprise may organize web pages targeted to different audiences into groups of web pages known as “web sites”. For instance, an enterprise may organize a set of web pages targeted to its employees into an intranet web site. Furthermore, in this instance, the enterprise may organize a set of web pages targeted to the public into an Internet web site. The enterprise may organize a set of web pages targeted to partner enterprises into an extranet web site.

In order to provide web pages, an enterprise may establish its own information technology infrastructure. Establishing an information technology infrastructure may require the purchase of one or more servers that provide the web pages and may require the purchase of bandwidth from a network access provider. In addition, the enterprise may be required to hire employees to administer the information technology infrastructure.

Expenses associated with establishing and maintaining the information technology infrastructure may be considerable. For instance, high-end servers may cost several thousand dollars each. Furthermore, the salary of a network administrator hired to configure and maintain the information technology infrastructure may be several thousand dollars per month.

In order to reduce expenses associated with establishing and maintaining its own information technology infrastructure, an enterprise may make a contract with a data center service provider. A data center service provider is an entity that operates a data center. A data center is a collection of servers and other network appliances that operate to perform network services on behalf of one or more subscribers. The contract may specify that, in exchange for a periodic fee, the data center service provider will provide network services on behalf of the enterprise. For instance, the data center service provider may agree to serve the enterprise's web pages.

The data center service provider may make many such contracts with many different enterprises, organizations, or individuals. Enterprises, organizations, and individuals that make contracts with a data center service provider for network services are referred to as “subscribers” or “tenants.”

In some circumstances, it is not necessary for a data center to include a server that is exclusively dedicated to providing network services on behalf of a single subscriber. For this reason, a single server in the data center may provide network service on behalf of a plurality of subscribers.

In order to provide network services, a server executes a set of one or more instances of one or more network service applications. A network service application is a software application that causes a computer that executes the network service application to provide a network service. For instance, a server may execute an instance of an Apache™ web server application that causes the server to serve web pages on behalf of a subscriber. When a server is providing network services on behalf of a plurality of subscribers, the server may execute separate instances of a single network service application for each subscriber in the plurality of subscribers. For example, a server may execute a first instance of the Apache™ web server application to serve web pages on behalf of a first subscriber and may execute a second instance of the Apache™ web server application to serve web pages on behalf of a second subscriber.

Each instance of a network service application may consume resources of a server that executes the instances of the network service application. For instance, each instance of a network service application may consume space in random access memory, may consume processor time, may consume bus time, and may consume other resources of the server. Consequently, as a server executes progressively more instances of a network service application, the performance of the server may progressively decrease.

### SUMMARY

This disclosure describes techniques of using a single instance of a network service application to provide a network service on behalf of multiple subscribers of a data center. As described herein, a data center may execute an instance of a service application that provides a service that is used by web applications that serve web sites associated with different subscribers of the data center. The instance of the service application stores service-specific data associated with the different web sites in separate partitions of a database. Storing the service-specific data associated with different web sites in separate partitions of the database enables the instance of the service application to control the data used to perform the service on a subscriber-by-subscriber basis while allowing for shared data between subscribers.

The techniques described in this disclosure may be realized in many ways. For example, the techniques described in this disclosure may be realized as a method that comprises storing, at a data center, a first website associated with a first subscriber of the data center. The method also comprises storing, at the data center, a second website associated with a second subscriber of the data center. In addition, the method comprises executing an instance of a service application that causes the data center to use data in a first set of partitions of a service database to perform a shared service for a web application that uses the shared service to serve web pages in the first website, the first set of partitions including partitions of the service database that are associated with the first subscriber. Executing the instance of the service application also causes the data center to use data in a second set of partitions of the service database to perform the shared service for a web application that uses the shared service to serve web pages in the second website, the second set of partitions including partitions of the service database that are associated with the second subscriber.

In another example, the techniques described in this disclosure may be realized as a computer-readable medium that comprises instructions that cause a computer that executes the instructions to store, at a data center, a first website associated with a first subscriber of the data center. The instructions also cause the computer to store, at the data center, a second website associated with a second subscriber of the data center. Moreover, the instructions cause the computer to execute an instance of a service application that causes the data center to use data in a first set of partitions of a service database to perform a shared service for a web application that uses the shared service to serve web pages in the first website, the first set of partitions including partitions of the service database that are associated with the first subscriber. The instance of the service application also causes the data center to use data in a second set of partitions of the service database to perform the shared service for a web application that uses the shared service to serve web pages in the second website, the second set of partitions including partitions of the service database that are associated with the second subscriber.

In another example, the techniques described in this disclosure may be realized as a data center that comprises a first content database that stores a first website that is associated with a first subscriber of the data center. The data center also comprises a second content database that stores a second website that is associated with a second subscriber of the data center. In addition, the data center comprises a service database that comprises a plurality of partitions. Moreover, the data center comprises a partition table that contains a plurality of entries that associate subscriber identifiers that identify subscribers of the data center with partition identifiers that identify ones of the partitions of the service database. The data center also comprises an application server that executes an instance of a service application that causes the application server to use the entries in the partition table to provide a mapping service that generates lists of partition identifiers associated with subscriber identifiers. The application server also executes an instance of a service application that causes the application server to (a) receive a first request to perform a shared service that specifies the first subscriber identifier; (b) send a request to the mapping service for a first list of partition identifiers associated with the first subscriber identifier; and (c) use data in partitions of the service database that are identified by partition identifiers in the first list of partition identifiers to perform the shared service. Furthermore, the instance of the service application causes the application server to (d) receive a second request to perform the shared service that specifies the second subscriber identifier, (e) send a request to the mapping service for a second list of partition identifiers associated with the second subscriber identifier, and (f) use data in partitions of the service database that are identified by partition identifiers in the second list of partition identifiers to perform the shared service. The data center also comprises a first web server that executes an instance of a first web application that causes the first web server to receive a request for a web page in the first website and to send, in response to the request for the web page in the first website, the first request to the instance of the service application. In addition, the data center comprises a second web server that executes an instance of a second web application that causes the second web server to receive a request for a web page in the second website and to send, in response to the request for the web page in the second website, the second request to the instance of the service application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram illustrating an example system in which a data center uses a service application instance that provides a shared service to a plurality of web application instances associated with a plurality of subscribers of the data center.

FIG. 2 is a block diagram illustrating an example software hierarchy.

FIG. 3 is a block diagram illustrating an example partition table.

FIG. 4 is a flowchart illustrating an example operation of a shared service.

### DETAILED DESCRIPTION

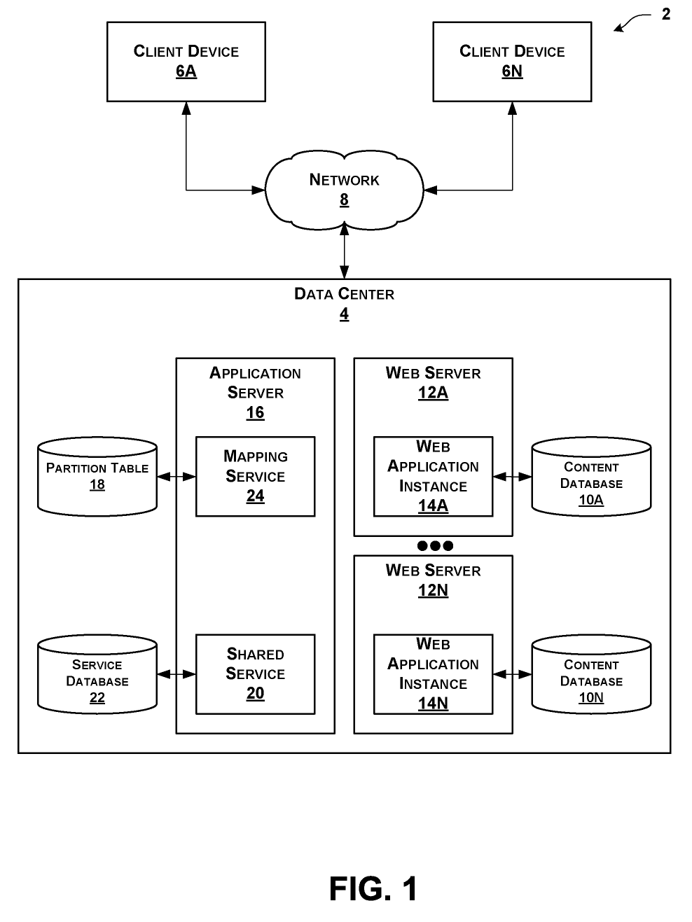

FIG. 1 is a block diagram illustrating an example system 2 in which a data center 4 uses a service application instance that provides a shared service to a plurality of web application instances associated with a plurality of subscribers of the data center. It should be appreciated that FIG. 1 is provided for explanatory purposes only and is not meant to be construed as the only possible implementation of the techniques of this disclosure. Rather, system 2 in FIG. 1 only represents one implementation among many possible implementations.

As described herein, a plurality of entities may make arrangements with an operator of data center 4. The entities may be enterprises, individuals, governments, organizations, and other types of entities. In each of these arrangements, the operator of data center 4 agrees to provide a web hosting service for the entities. As used in this disclosure, a “subscriber” is an entity that has made an arrangement with an operator of a data center in which the operator of the data center agrees to provide a web hosting service for the entity. Data center 4 may associate each subscriber of data center 4 with a distinct subscriber identifier that identifies the subscriber. A subscriber identifier may be a number, a string of characters, or another type of data that uniquely identifies a subscriber.

In order to provide web hosting services for the subscribers, data center 4 uses at least one service application instance that provides a service to a plurality of web application instances that serve web pages in websites of the entities. Using such a service application instance to provide the service to the web application instances may require fewer computational resources than individual service application instances that provide the service to only a single one of the web application instances. For this reason, system 2 may be more scalable than systems in which individual service application instances provide the service to individual web application instances.

As illustrated in the example of FIG. 1, system 2 includes a plurality of client devices 6A through 6N (collectively, “client devices 6”). Client devices 6 may be personal computers, mobile telephones, portable handheld devices, personal music players, laptop computers, television set top boxes, web caching servers, or other types of devices.

A network 8 facilitates communication between client devices 6 and data center 4. Network 8 may be any of a wide variety of different types of network that facilitate communication between client devices 6 and data center 4. For instance, network 8 may be a local area network, a wide area network, a global area network, a metropolitan area network. Network 8 may include many network devices and many network links. The network devices in network 8 may include bridges, hubs, switches, firewalls, routers, load balancers, and other types of network devices. The network links in network 8 may include wired links (e.g., coaxial cable, fiber optic cable, 10BASE-T cable, 100BASE-TX cable, etc.) and may include wireless links (e.g., WiFi links, WiMax links, wireless broadband links, mobile telephone links, Bluetooth links, infrared links, etc.).

Data center 4 is a collection of network devices that provide network services for a plurality of subscribers. Network devices in data center 4 may be located in a single geographic location. Alternatively, network devices in data center 4 may be distributed across a plurality of geographic locations. For instance, one or more network devices of data center 4 may be located in a facility in Korea and one or more network devices of data center 4 may be located in a facility in France.

In the example of FIG. 1, data center 4 includes content databases 10A through 10N (collectively, “content databases 10”). Each of content databases 10 stores a site group. As used in this disclosure, a “site group” is a set of related websites. A website is a collection of web pages, images, videos or other digital assets that is accessible via a network. A web page is a document that is displayable by a web browser application.

Websites in a site group may be related in a variety of different ways. For example, Contoso Industries may be a subscriber of data center 4. In this example, content database 10A may store a site group that includes a web site associated with Contoso Industries that is publicly available on the Internet, an intranet website that is only available to employees of Contoso Industries, and an extranet website that is available to entities that are collaborating with Contoso Industries.

Data center 4 may tag each webpage in the websites stored content databases 10 with a subscriber identifier of a subscriber of data center 4. Data center 4 may tag web pages in different site groups with the same subscriber identifier. As described below, the subscriber identifiers may be used when processing requests related to the web pages. Furthermore, data center 4 may associate each of the site groups stored in content databases 10 with a site group identifier that identifies the site group. A site group identifier may be a number, a string of characters, or another type of data that uniquely identifies a site group.

Content databases 10 may be implemented in a variety of different ways. For example, each of content databases 10 may store web pages and other items in a site group in a separate SQL database. In another example, content databases 10 may be implemented as a single database that stores site groups associated with all of the subscribers of data center 4.

In the example of FIG. 1, data center 4 includes a set of web servers 12A through 12N (collectively, “web servers 12”). Web servers 12 execute web application instances 14A through 14N (collectively, “web application instances 14”). Each of web application instances 14 is an instance of a web application. A web application is an application that causes a computer that executes the web application to provide a network service that is accessible via a network. Each of web application instances 14 may cause web servers 12 to provide a web hosting service for one or more of the websites stored in content databases 10. As used herein, a web hosting service is a type of network service that makes websites available on the World Wide Web.

In addition to web application instances 14, web servers 12 may execute instances of web applications that provide other services. These services may cause web servers 12 to provide an authentication service, a directory service, a Dynamic Host Configuration Protocol (DHCP) service, a Domain Name Service (DNS), an e-mail service, a network file system service, and other types of network services.

In the example of FIG. 1, data center 4 includes an application server 16 that executes an instance of a service application that causes application server 16 to provide a mapping service 24 and an instance of a service application that causes application server 16 to provide a shared service 20. In the context of system 2, a “service application” is an application that causes a computer that executes the service application to provide a service that is used by another service within data center 4. Application server 16 may execute the instance of the service application that causes application server 16 to provide shared service 20 as a single process. Each service provided by application server 16 may be associated with a service identifier that identifies the service. A service identifier may be number, a process identifier, a string of characters, or another type of data that identifies the service. It should be appreciated that application service 16 may execute instances of applications that cause application server 16 to provide other services in addition to mapping service 24 and shared service 20.

Mapping service 24 may receive a request from a service for a list of partition identifiers associated with a subscriber identifier. When mapping service 24 receives such a request, mapping service 24 uses a partition table 18 to generate the list of partition identifiers. In one example implementation, partition table 18 includes a set of entries. Each entry in partition table 18 may specify a subscriber identifier, a service identifier, and a partition identifier. In order to generate the list of partition identifiers, mapping service 24 identifies the entries in partition table 18 that specify the subscriber identifier specified in the request and that specify the service identifier of the service that requested the list of partition identifiers. Mapping service 24 may then return a list of partition identifiers that includes the partition identifiers specified in the identified entries of partition table 18.

Partition table 18 may include entries that specify a single service identifier, a single partition identifier, and different subscriber identifiers. Moreover, partition table 18 may include entries that specify a single subscriber identifier, a single service identifier, and different partition identifiers. In this way, a list of partition identifiers associated with a first subscriber identifier may share a partition identifier with a list of partition identifiers associated with a second subscriber identifier. In addition, partition table 18 may include entries that specify a single subscriber identifier, a single partition identifier, and different service identifiers.

As mentioned briefly above, application service 16 executes an instance of a service application that causes application service 16 to provide a shared service. For example, shared service 20 may be a database access service, a document format translation service, a document language translation service, a website search service, or another other service used by one or more other services within data center 4.

Web application instances 14 may utilize shared service 20 when performing network services. For example, shared service 20 may calculate dates of lunar eclipses. In this example, web application instance 14A may receive a request for a web page that lists the dates of the next ten lunar eclipses. In response to the request, web application instance 14A may utilize shared service 20 to calculate the dates of the next ten lunar eclipses. After using shared service 20 to calculate the dates of the next ten lunar eclipses, web application instance 14 may dynamically generate the requested web page using the calculated dates.

More than one web application may utilize shared service 20 even though shared service 20 is provided by a single instance of a service application executing on application server 16. That is, application server 16 does not execute separate instances of a service application that provides shared service 20 for each of web application instances 14. For example, web application instance 14A may utilize shared service 20 to calculate dates of lunar eclipses and web application instance 14N may utilize shared service 20 to calculate dates of lunar eclipses.

Not executing separate instances of a service application that provide a service for each of web application instances 14 may conserve computational resources of application server 16. For example, each instance of a service application may consume space in memory to store the machine code of the service application, intermediate computational data, security attributes, processor state information (e.g., register content), and other information related to the instance of the service application. In this example, storing such information related to multiple instances of the service application may degrade the performance of application server 16.

Shared service 20 may operate synchronously, asynchronously, or both synchronously and asynchronously. When shared service 20 operates synchronously, shared service 20 acts in response to requests from ones of web application instances 14. For example, if shared service 20 is a project management service, shared service 20 may return a list of people assigned to a project in response to a request from one of web application instances 14 for the list of people assigned to the project. When shared service 20 operates asynchronously, shared service 20 operates without a prior request from one of web application instances 14. For example, if shared service 20 is a document format translation service, shared service 20 may translate documents into a different format without a request to translate the documents from one of web application instances 14. When shared service 20 operates synchronously and asynchronously, one aspect of shared service 20 may operate in response to a request from one of web application instances 14 and another aspect of shared service 20 may operate without receiving a request from one of web application instances 14. For example, if shared service 20 is an indexing service, shared service 20 may use an index to search for web pages in response to a search request generated by web application instance 14A. Furthermore, in this example, service application instance 20 may generate the index without a request to generate the index from one of web application instances 14.

Shared service 20 may generate and use data that is specific to individual ones of the subscribers of data center 4. This disclosure uses the term “site-specific data” to refer to data used or generated by shared service 20 that is specific to individual ones of the subscriber of data center 4. For example, service application instance 20 may be an indexing service that generates an index to information contained in web pages in the websites of the subscribers. In this example, shared service 20 may use the index to identify web pages that contain information described by a query. In another example, shared service 20 may be a document format translation service that causes application server 16 to generate Portable Document Format (PDF) versions of word processor documents included in the websites of the subscribers.

In the example of FIG. 1, shared service 20 stores service-specific data in a service database 22. In order to ensure that service-specific data is not improperly disclosed, shared service 20 segregates the service-specific data into separate partitions within service database 22. A partition of service database 22 is a division of the service database into distinct independent parts. The partitions may be logical partitions and/or physical partitions. Each partition of service database 22 is identified by a partition identifier. A partition identifier may be a number, a string of characters, or another type of identifier.

Shared service 20 may segregate the service-specific data into partitions in a variety of ways. For example, shared service 20 may maintain a separate partition for each subscriber of data center 4 that is permitted to use shared service 20. In other words, in this example, shared service 20 may store data associated with web pages tagged with a first subscriber identifier in a first partition of service database 22 and may store data associated with web pages tagged with a second subscriber identifier in a second partition of service database 22. In another example, shared service 20 may be a document format translation service and service database 22 may be implemented as a relational database. In this example, service database 22 may contain a first table that stores translations of documents in a website of a first subscriber and a second table that stores translations of documents in a website of a second subscriber.

When shared service 20 needs to generate or use data that is associated with web pages tagged with a specific subscriber identifier, shared service 20 first uses mapping service 24 to identify a set of partitions of service database 22. In order to use mapping service 24, shared service 20 may send a request that specifies the subscriber identifier and the service identifier of service application instance 20 to mapping service 24. In response to the request, mapping service 24 sends a list of partition identifiers to shared service 20. After shared service 20 receives the list of partition identifiers, shared service 20 may generate and/or use data in the partitions of service database 22 that are identified by the partition identifiers in the list of partition identifiers to perform the service with regard to the site group associated with the subscriber identifier. Shared service 20 is not permitted to generate and/or use data in partitions of service database 22 that are not identified by the partition identifiers in the list of partition identifiers. For example, when shared service 20 is an indexing service and shared service 20 receives a request that specifies a given subscriber identifier, shared service 20 may only use parts of the index that are stored in a partition of service database 22 when the list of partition identifiers includes the partition identifier of the partition. Because, in this example, partitions of service database 22 store data associated with individual websites, shared service 20 only identifies web pages that contain information described by the query when the web pages are in a website associated with partitions of service database 22 to which the given subscriber identifier are associated. For this reason, a user of a client device who is searching for web pages in a website associated with a first subscriber does not receive references to web pages in a website associated with a second subscriber.

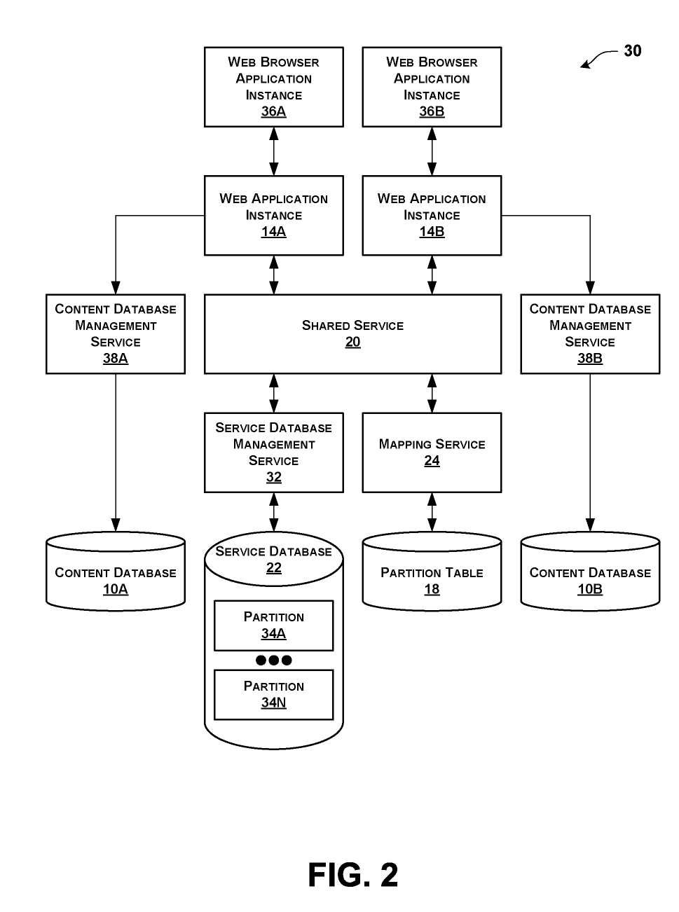

FIG. 2 is a block diagram illustrating an example software hierarchy 30 used in data center 4 (FIG. 1). As illustrated in the example of FIG. 2, software hierarchy 30 includes an instance of a service database management application that causes application server 16 to provide a service database management service 32. Service database management service 32 allows services that subscribe to service database management service 32 to submit queries to service database management service 32 and to receive data in service database 20 that is described by the queries.

Furthermore, service database management service 32 allows services that subscribe to service database management service 32 to store service-specific data into service database 22. As illustrated in the example of FIG. 2, shared service 20 may use service database management service 32 to store service-specific data into a set of partitions 34A through 34N (collectively, “partitions 34”) within service database 22.

Software hierarchy 30 includes an instance of a mapping service application that causes application server 16 to provide a mapping service 24. Mapping service 24 allows services that subscribe to mapping service 24 to request of a list of partition identifiers associated with a subscriber identifier. When mapping service 24 receives a request from a service, mapping service 24 uses partition table 18 to identify partition identifiers that are in entries of partition table 18 that specify the subscriber identifier and the service identifier of the requesting service. Mapping service 24 may then return a list of the identified partition identifiers to the requesting service. Furthermore, mapping service 24 may allow services that subscribe to mapping service 24 to create or modify entries in partition table 18.

Software hierarchy 30 also includes a content database management service 38A and a content database management service 38B. Content database management service 38A allows services that subscribe to content database management service 38A to retrieve information in content database 10A. Similarly, content database management service 38B allows services that subscribe to content database management service 38B to retrieve information in content database 10B.

In the example of FIG. 2, software hierarchy 30 includes shared service 20. As discussed above, shared service 20 may be any of a wide variety of services including indexing/search services, document formation translation services, scheduling services, and so on. Shared service 20 may use mapping service 24 to retrieve a list of partition identifiers associated with a subscriber identifier. After shared service 20 receives the list of partition identifiers, shared service 20 uses service database management service 32 to access data in the partitions of service database 22 that are identified by the partition identifiers in the list of partition identifiers.

Web application instance 14A may provide a web hosting service. The web hosting service provided by web application instance 14A allows other services to request web pages associated with a first site group. When the web hosting service provided by web application instance 14A receives a request for a web page in the first site group, the web hosting service performs steps to generate or retrieve the requested web page and to transmit the requested web page. Web application instance 14A may utilize shared service 20 and content database management service 38A when generating or retrieving the requested web page. In the example of FIG. 2, a web browser application instance 36A that operates on client device 6A uses the web hosting service provided by web application instance 14A to request and receive web pages in the first site group.

The web hosting service provided by web application instance 14B allows other services to request web pages associated with a second site group. When the web hosting service provided by web application instance 14B receives a request for a web page in the second site group, the web hosting service performs steps to generate or retrieve the requested web page and to transmit the requested web page. Web application instance 14B may utilize shared service 20 and content database management service 38B when generating or retrieving the requested web page. In the example of FIG. 2, a web browser application instance 36B that operates on client device 6B uses the web hosting service provided by web application instance 14B to request and receive web pages in the second site group.

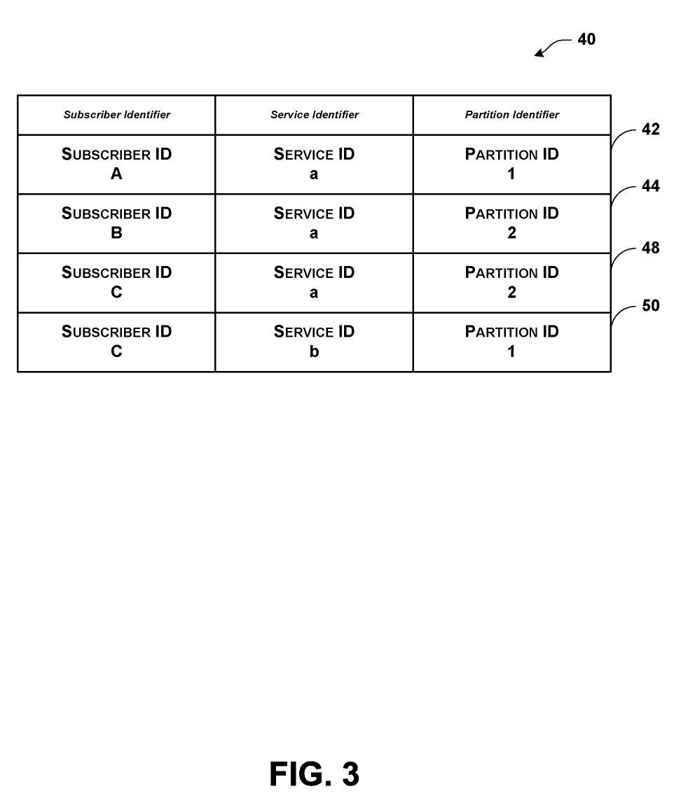

FIG. 3 is a diagram illustrating an example partition table 40. Partition table 40 may represent the content of partition table 18 (FIG. 1). However, it should be appreciated that partition table 40 illustrates one example partition table that may be used in one exemplary configuration of data center 4. Partition tables used in different configurations of data center 4 are likely to specify different identifiers. Moreover, it should be appreciated that partition table 40 does not represent an exclusive way of formatting a partition table used in data center 4.

As illustrated in the example of FIG. 3, partition table 40 includes an entry 42 that specifies a subscriber identifier “A”, a service identifier “a”, and a partition identifier “1”. Because partition table 40 includes this entry, when mapping service 24 receives a request for a list of partition identifiers associated with a subscriber identifier “A” from a service having a service identifier “a”, mapping service 24 identifies the partition identifier “1” for inclusion in the list of partition identifiers. In addition, partition table 40 includes an entry 44 that specifies a subscriber identifier “B”, a service identifier “a”, and a partition identifier “2”.

Partition table 40 includes an entry 48 that specifies a subscriber identifier “C”, a service identifier “a”, and the partition identifier “2”. In addition, partition table 40 includes an entry 50 that specifies the subscriber identifier “C”, the service identifier “b”, and the partition identifier “1”. Thus, when mapping service instance 24 receives a request for a list of partition identifiers associated with a subscriber identifier “C” from a service having a service identifier “a”, mapping service 24 identifies the partition identifier “2” for inclusion in the list of partition identifiers, but not the partition identifier “1”. However, when mapping service 24 receives a request for a list of partition identifiers associated with a subscriber identifier “C” from a service having a service identifier “b”, mapping service instance 24 identifies the partition identifier “1” for inclusion in the list of partition identifiers, but not the partition identifier “2”.

To illustrate why it may be useful for partition table 30 to include entries (such as entries 44 and 48) that specify different subscriber identifiers, but share common service identifiers and common partition identifiers, consider the following example. Let partition identifier “2” identify a partition that stores service-specific data related to a web site owned by a subscriber identified by subscriber identifier “B”. Let shared service 20 be a search service and be identified by the service identifier “a”. In this example, shared service 20 could receive a search request from a web application instance that hosts a web page tagged with subscriber identifier “C”. In response to this request, shared service 20 would be able to search web pages in the website owned by the subscriber identified by subscriber identifier “B”.

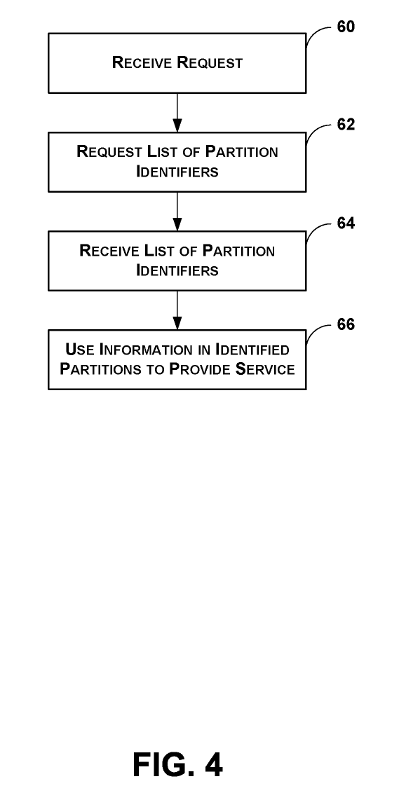

FIG. 4 is a flowchart illustrating an example operation of shared service 20. Initially, shared service 20 receives a request that specifies a subscriber identifier from a web application instance (e.g., web application instance 14A) (60). In a first example, shared service 20 may be an indexing service. In this first example, shared service 20 may receive a request that specifies a search string (e.g., a set of keywords) that describes desired information. In a second example, shared service 20 is an instance of a legal docketing service that calculates due dates for attorney actions. In this second example, shared service 20 may receive a request to update a due date of a particular attorney action.

When shared service 20 receives the request, shared service 20 may send a request to mapping service 24 for a list of partition identifiers associated with the subscriber identifier specified by the request (62). Subsequently, shared service 20 receives a list of one or more partition identifiers associated with the subscriber identifier specified by the request (64).

After receiving the list of partition identifiers, shared service 20 may use information in partitions of service database 22 that are identified by the partition identifiers in the list of partition identifiers (66). Shared service 20 may use the information in the identified partitions in a wide variety of ways. In a first example, shared service 20 may be the indexing service. In this first example, shared service 20 may search the index information in the identified partitions to identify web pages that contain the desired information described by the search string specified by the request. In a second example, shared service 20 is the legal docketing service. In this second example, shared service 20 may use the information in the identified partitions to update due dates in the identified partitions that are dependent on the updated date for the attorney action. This second example illustrates that shared service 20 does not necessary return data in response to a request.

It is to be understood that the embodiments described herein may be implemented by hardware, software, firmware, middleware, microcode, or any combination thereof. When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes and instructions may be stored in computer-readable media and executed by processors. The memory unit may be implemented within the processor or external to the processor, in which case it can be communicatively coupled to the processor via various means as is known in the art.

Various embodiments of the invention have been described. These and other embodiments are within the scope of the following claims.

We claim:

1. A method comprising:
storing, at a data center, a first website associated with a first subscriber of the data center;
storing, at the data center, a second website associated with a second subscriber of the data center; and
executing an instance of a service application that causes the data center to:
(i) use data in a first set of partitions of a service database to perform a shared service for a web application that uses the shared service to serve web pages in the first website, the first set of partitions including partitions of the service database that are associated with the first subscriber; and
(ii) use data in a second set of partitions of the service database to perform the shared service for a web application that uses the shared service to serve web pages in the second website, the second set of partitions including partitions of the service database that are associated with the second subscriber.

2. The method of claim 1,
wherein the web application that uses the shared service to serve web pages in the first website is a first web application; and
wherein the method further comprises executing instructions of the first web application that cause the data center to generate a request for the shared service that specifies a first subscriber identifier that identifies the first subscriber; and
wherein executing the instance of the service application comprises executing instructions of the instance of the service application that cause the data center to use the first subscriber identifier to identify the first set of partitions.

3. The method of claim 2,
wherein the method further comprises receiving a request from a client device for a web page in the first website; and
wherein executing the instructions of the first web application that cause the data center to generate the request for the shared service that specifies the first subscriber identifier comprises executing the instructions of the first web application that cause the data center to generate the request for the shared service that specifies the first subscriber identifier in response to receiving the request from the client device.

4. The method of claim 2,
wherein the method further comprises:
storing a partition table that contains a plurality of entries that associate subscriber identifiers of subscribers of the data center with partition identifiers that identify partitions in the service database; and
executing an instance of a service application that causes the data center to use the entries in the partition table to provide a mapping service that generates lists of partition identifiers associated with subscriber identifiers; and
wherein executing instructions of the instance of the service application that cause the data center to use the subscriber identifier of the first subscriber to identify the first set of partitions comprises executing instructions of the instance of the service application that cause the data center to:
send a request to the mapping service for a first list of partition identifiers associated with the first subscriber identifier; and
receive the first list of partition identifiers, wherein the partition identifiers in the first list of partition identifiers identify the partitions in the first set of partitions.

5. The method of claim 4,
wherein the method further comprises:
executing instructions of the first web application that cause the data center to send to the shared service a request that specifies a search string that describes desired information;
executing instructions of the service application instance that cause the data center to store a first portion of an index in a first partition in the partitions of the service database, the first portion of the index containing data that indicates information in the web pages in the first website; and
executing instructions of the service application instance that cause the data center to store a second portion of the index in a second partition in the partitions of the service database, the second portion of the index containing data that indicates information in the web pages in the second website;
wherein executing the instance of the service application comprises executing instructions of the instance of the service application that cause the data center to:
search the first portion of the index for web pages that include the desired information described by the search string when the first list of partition identifiers includes a partition identifier that identifies the first partition; and
search the second portion of the index for web pages that include the desired information described by the search string when the first list of partition identifiers includes a partition identifier that identifies the second partition.

6. The method of claim 1, wherein the first set of partitions includes a shared partition that is in the second set of partitions.

7. The method of claim 1, wherein the first set of partitions includes at least two of the partitions of the service database.

8. The method of claim 1,
wherein the web application that uses the shared service to serve web pages in the first website is a first web application;
wherein the method further comprises receiving a request for a first web page in the first website from a client device;
wherein executing the instance of the service application comprises executing instructions of the instance of the service application that cause the data center to use data in the first set of partitions to generate a set of data, thereby performing the shared service;
wherein the method further comprises executing instructions of the first web application that cause the data center to:
use the set of data to generate the requested web page; and
send the requested web page to the client device.

9. The method of claim 1, wherein executing the instance of the service application comprises executing the instance of the service application as a single process on a server in the data center.

10. A computer-readable medium comprising instructions that cause a computer that executes the instructions to:
store, at a data center, a first website associated with a first subscriber of the data center;
store, at the data center, a second website associated with a second subscriber of the data center; and
execute an instance of a service application that causes the data center to:
(i) use data in a first set of partitions of a service database to perform a shared service for a web application that uses the shared service to serve web pages in the first website, the first set of partitions including partitions of the service database that are associated with the first subscriber; and
(ii) use data in a second set of partitions of the service database to perform the shared service for a web application that uses the shared service to serve web pages in the second website, the second set of partitions including partitions of the service database that are associated with the second subscriber.

11. The computer-readable medium of claim 10,
wherein the web application that uses the shared serve to service web pages in the first website is a first web application; and
wherein the instructions further cause the computer to execute instructions of the first web application that cause the data center to generate a request for the shared service that specifies a first subscriber identifier that identifies the first subscriber; and
wherein the instructions that cause the computer to execute the instance of the service application cause the computer to execute instructions of the instance of the service application that cause the data center to use the first subscriber identifier to identify the first set of partitions.

12. The computer-readable medium of claim 11,
wherein the instructions further cause the computer to receive a request from a client device for a web page in the first website; and
wherein the instructions that cause the computer to execute the instructions of the first web application that cause the data center to generate the request for the shared service that specifies the first subscriber identifier cause the computer to execute the instructions of the first web application that cause the data center to generate the request for the shared service that specifies the first subscriber identifier in response to receiving the request from the client device.

13. The computer-readable medium of claim 10, wherein the first set of partitions includes a shared partition that is in the second set of partitions.

14. The computer-readable medium of claim 10, wherein the first set of partitions includes at least two of the partitions of the service database.

15. A data center comprising:
a first content database that stores a first website that is associated with a first subscriber of the data center;
a second content database that stores a second website that is associated with a second subscriber of the data center;
a service database that comprises a plurality of partitions;
a partition table that contains a plurality of entries that associate subscriber identifiers that identify subscribers of the data center with partition identifiers that identify ones of the partitions of the service database;
an application server that:
(i) executes an instance of a service application that causes the application server to use the entries in the partition table to provide a mapping service that generates lists of partition identifiers associated with subscriber identifiers; and
(ii) executes an instance of a service application that causes the application server to:
(a) receive a first request to perform a shared service, wherein the first request specifies the first subscriber identifier;
(b) send a request to the mapping service for a first list of partition identifiers associated with the first subscriber identifier;
(c) use data in partitions of the service database that are identified by partition identifiers in the first list of partition identifiers to perform the shared service;
(d) receive a second request to perform a shared service, wherein the second request specifies the second subscriber identifier;
(e) send a request to the mapping service for a second list of partition identifiers associated with the second subscriber identifier; and
(f) use data in partitions of the service database that are identified by partition identifiers in the second list of partition identifiers to perform the shared service;
a first web server that executes an instance of a first web application that causes the first web server to:
(i) receive a request for a web page in the first website; and
(ii) in response to the request for the web page in the first website, send
the first request to the instance of the service application; and
a second web server that executes an instance of a second web application that causes the second web server to:
(i) receive a request for a web page in the second website; and
(ii) in response to the request for the web page in the second website, send the second request to the instance of the service application.

16. The system of claim 15,
wherein the request for the web page in the first website specifies a search string that describes desired information;
wherein the instance of the service application stores a first portion of an index in a first partition in the plurality of partitions, the first portion of the index containing data that indicates information in web pages in the first website;
wherein the instance of the service application stores a second portion of an index in a second partition in the plurality of partitions, the second portion of the index containing data that indicates information in web pages in the second website;
wherein the instance of the service application searches the first portion of the index for web pages that include the desired information described by the search string when the first list of partition identifiers includes a partition identifier that identifies the first partition; and
wherein the instance of the service application searches the second portion of the index for web pages that include the desired information described by the search string when the first list of partition identifiers includes a partition identifier that identifies the second partition, thereby causing the application server to use data in the partitions of the service database that are identified by the partition identifiers in the first list of partition identifiers to perform the shared service.

17. The system of claim 15, wherein the first content database stores a site group that includes the first website and a third website that is associated with the first subscriber.

18. The system of claim 15, wherein the instance of the service application is a single process.

19. The system of claim 15, wherein the instance of the service application further causes the application server to store data in the service database such that a portion of the data associated with the first website are stored in a first partition in the set of partitions and a portion of the data associated with the second website are stored in a second partition in the set of partition.

20. The system of claim 19, wherein the first partition list includes a partition identifier that identifies the first partition and a partition identifier that identifies the second partition.
